(19) United States
(12) Patent Application Publication
(10) Pub. No.: US 2006/0144919 A1
(43) Pub. Date: Jul. 6, 2006

(54) Pharmaceutical dispensing device and a method of using the same

(76) Inventor: Greg Tong, Palos Verdes, CA (US)

Correspondence Address: STETINA BRUNDA GARRED & BRUCKER, 75 ENTERPRISE, SUITE 250, ALISO VIEJO, CA, 92656, US

(21) Appl. No.: 11/030,371

(22) Filed: Jan. 6, 2005

(51) Int. Cl. G06F 17/00; G06F 7/08

(52) U.S. Cl. 235/375; 235/381

(57) ABSTRACT

A dispensing device for retaining a bar coded prescription label including a prescription label bar code and a bar coded container including a container bar code together wherein the container may contain a pharmaceutical associated with the bar codes of the prescription label and container. The device may comprise a substrate body having disposed thereabout a substantially flat and rigid first portion and a second portion. The first and second portions may have affixed thereto the prescription label and the container, respectively.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention relates generally to a device for and a method of dispensing a pharmaceutical, and more particularly to a device for and a method of retaining a pharmaceutical with a prescription label bar code and a container bar code.

Pharmacists are required to fill prescriptions in an accurate and a time efficient manner. To this end, pharmacists employ processes and systems to reduce the possibility that the wrong pharmaceutical is dispensed to the patient. One aspect of the employed processes and systems relate to the packaging in which the prescribed pharmaceutical is dispensed to the patient, and more particularly, to bar codes of the pharmaceutical packaging.

In particular, currently, a prescription label is prepared by the pharmacist which may be attached to a manufacturer's box containing a manufacturer's container. The prescription label and the manufacturer's box are bar coded and scanned after they have been attached to each other to ensure that the correct pharmaceutical is dispensed to the patient. However, this bar code scanning process is not perfect in ensuring that the correct pharmaceutical is dispensed to the patient.

For example, if the manufacturer's box is too small for the prescription label to be attached or adhered thereto, the pharmacist may remove the manufacturer's container (e.g., small glass vial) from the manufacturer's box and insert the manufacturer's container into a pharmacist-provided container (e.g., large amber colored plastic vial). The prescription label is then attached to the pharmacist-provided container. After the prescription label is attached to the pharmacist-provided container, the bar codes of the prescription label and the manufacturer's box are scanned to ensure that the correct pharmaceutical is dispensed to the patient. However, the pharmacist may mistakenly attached the wrong label to the pharmacist-provided container, especially when the pharmacist is filling many different prescriptions simultaneously. Unfortunately, even though the scanning of the prescription label and manufacturer's box indicates that the correct pharmaceutical is dispensed to the patient, the wrong pharmaceutical is actually dispensed to the patient. Moreover, this scanning process takes more time in contrast to the situation where the prescription label may be directly attached or adhered to the manufacturer's box because this scanning process requires that the manufacturer's container be removed from the manufacturer's box and inserted into the pharmacist-provided container. Additionally, the manufacturer's box and the prescription label which are separated from each other must be paired up for scanning thereby consuming more of the pharmacist's time.

Another aspect of the prescription filling process relates to the process of determining an expiration date of the pharmaceutical. Many pharmaceuticals (e.g., eye drops) expire twenty eight (28) or thirty (30) days after opening—the expiration date is not based on the dispensing date but is based on the date of first administration. Typically, a nurse may initially administer a pharmaceutical to a patient and indicate on the prescription label its corresponding expiration date. To this end, the nurse will look up on a calendar and count the number of days starting from the date of first administration. However, this method is not accurate and sometimes yields erroneous expiration dates.

Accordingly, there is a need in the art for an improved device for and method of dispensing a pharmaceutical.

### BRIEF SUMMARY OF THE INVENTION

The deficiencies in the prior art are addressed in the embodiments of the present invention illustrated herein. In an embodiment of the present invention, a dispensing device may be provided. The dispensing device may serve the purpose of retaining a bar coded prescription label including a prescription label bar code and a bar coded container including a container bar code together. The bar coded container may further contain a pharmaceutical associated with the prescription label bar code and the container bar code.

The device may comprise a substrate body, a first portion and a second portion. The substrate body, first portion, second portion or combinations thereof may be fabricated from a unitary material. The substrate body may be fabricated from a resilient material such as paper board material and/or plastic. The first portion may be substantially flat and rigid. Moreover, the first portion may be disposed about the substrate body for affixing the bar coded prescription label to the substrate body. In this regard, the first portion may be sized and configured to the prescription label. The second portion may also be disposed about the substrate body for affixing the bar coded container thereto. By way of example and not limitation, the bar coded container may be affixed to the second portion via an adhesive interposed between the second portion and the container. In this regard, the adhesive may be sized and configured to a back surface of the container.

Alternatively, the bar coded container may be affixed to the second portion via a receptacle which is attached to the second portion and defines a cavity for receiving the bar coded container. More particularly, the receptacle may be adhered to the second portion via an adhesive. In this regard, an area of the adhesive may be sized and configured to a back surface of the receptacle. The receptacle may further define an aperture for inserting and removing the bar coded container therein and therefrom, respectively. The receptacle may further include a flap which may be attached to an edge of the aperture and foldable over the aperture to a closed position for blocking the aperture and preventing the bar coded container contained in the receptacle cavity from being removed from the cavity. The receptacle discussed above may be a pouch, envelope or bag.

The device may further comprise a chart indicated on the substrate body. In this regard, the chart may be indicated on the substrate body by imprinting the chart, lithographic printing the chart, adhering a sheet of paper with the chart printed thereon to the substrate body. The chart may serve the purpose of allowing a user to look up an expiration date of the pharmaceutical. The substrate body may also define an expiration date portion such that an expiration date indicia of the pharmaceutical may be indicated on the expiration date portion.

In another embodiment of the present invention, a dispensing device may comprise a substrate body and a substantially flat and rigid portion. The substrate body may define a cavity and an aperture which may lead to the cavity. The aperture may be for the purpose of inserting and removing the bar coded container into and out of, respectively, the cavity. The cavity may be sized and configured to receive the bar coded container. The substantially flat and rigid portion may be disposed about the substrate for affixing the bar coded prescription label thereto.

The substrate body may be transparent. More particularly, a portion of the substrate body may be transparent such that a bar coded container placed within the cavity may have its container bar code optically scanned from outside of the container.

The device may further comprise a flap, body closure button, tie string and flap closure button. The flap may be attached to an edge of the aperture. This flap may also be traversable to a closed position. The tie string and the flap closure button may be attached to the flap wherein the flap may be traversed to the closed position and the tie string wrapped around the body closure button and the flap closure button to lock the flap in the closed position preventing removal of the bar coded container inserted into the cavity.

The substrate body of the device may include a first substrate and a second substrate. In this regard, the cavity may be defined by a bubble formed in the first substrate and the second substrate.

In another embodiment of the present invention, a method of using the dispensing device is provided. The first step may include the step of providing a bar coded container having a container bar code. The second step may include the step of providing a pharmaceutical contained in the bar coded container. The third step may include the step of providing a bar coded prescription label including a prescription label bar code. The information indicated on the prescription label and the prescription label bar code may be based on the pharmaceutical contained in the bar coded container. The fourth step may include the step of providing a dispensing device for retaining the bar coded prescription label and the bar coded container together. In relation to the dispensing device, the same may comprise a substrate body, a substantially rigid and flat first portion disposed about the substrate body, and a second portion disposed about the substrate body for affixing the bar coded container to the substrate body.

The fifth step may include the step of affixing the bar coded prescription label to the first portion. In particular, this step may comprise the step of adhering the bar coded prescription label to the first portion. The sixth step may include the step of affixing the bar coded container to the second portion. In this regard, if the substrate body of the device defines a cavity for receiving the bar coded container then the affixing the bar coded container step may comprise the step of inserting the bar coded container into the cavity. Alternatively, if the device further comprises a receptacle attached to the device second portion then the affixing the bar coded container step may comprise the step of placing the bar coded container into the receptacle. The seventh step may include the step of scanning the container bar code and the prescription label bar code. It is contemplated within the scope of the present invention that the steps of the method enumerated above may be performed in any order.

### BRIEF DESCRIPTION OF THE DRAWINGS

An illustrative and presently preferred embodiment of the present invention is shown in the accompanying drawings in which:

FIG. 1 is a schematic diagram illustrating the steps of prescribing a pharmaceutical to a patient, dispensing/filling the prescribed pharmaceutical to the patient in a pharmaceutical dispensing device, and collecting a plurality of filled prescriptions;

FIG. 2 is an exploded view of a first embodiment of the pharmaceutical dispensing device, prescription label and pharmaceutical container shown in FIG. 1 wherein the device may have a substantially flat and rigid first portion for affixing the prescription label thereto and an adhesive placed on a second portion for affixing the pharmaceutical container thereto;

FIG. 3 is a chart to determine an expiration date of a dispensed pharmaceutical affixable on a back surface of the pharmaceutical dispensing device;

FIG. 3a is a sub-chart to determine the expiration date of the dispensed pharmaceutical when the pharmaceutical is initially administered in January in non-leap years;

FIG. 3b is a sub-chart to determine the expiration date of the dispensed pharmaceutical when the pharmaceutical is initially administered in January in leap years;

FIG. 3c is a sub-chart to determine the expiration date of the dispensed pharmaceutical when the pharmaceutical is initially administered in February in non-leap years;

FIG. 3d is a sub-chart to determine the expiration date of the dispensed pharmaceutical when the pharmaceutical is initially administered in February in leap years;

FIG. 3e is a sub-chart to determine the expiration date of the dispensed pharmaceutical when the pharmaceutical is initially administered in March, May, August or October;

FIG. 3f is a sub-chart to determine the expiration date of the dispensed pharmaceutical when the pharmaceutical is initially administered in April, June, September or November;

FIG. 3g is a sub-chart to determine the expiration date of the dispensed pharmaceutical when the pharmaceutical is initially administered in July or December;

FIG. 4 is a chart to determine the expiration date of a dispensed pharmaceutical affixable on a back surface of the pharmaceutical dispensing device;

FIG. 4a is a sub-chart to determine the expiration date of the dispensed pharmaceutical when the pharmaceutical is initially administered in January in non-leap years;

FIG. 4b is a sub-chart to determine the expiration date of the dispensed pharmaceutical when the pharmaceutical is initially administered in January in leap years;

FIG. 4c is a sub-chart to determine the expiration date of the dispensed pharmaceutical when the pharmaceutical is initially administered in February in non-leap years;

FIG. 4d is a sub-chart to determine the expiration date of the dispensed pharmaceutical when the pharmaceutical is initially administered in February in leap years;

FIG. 4e is a sub-chart to determine the expiration date of the dispensed pharmaceutical when the pharmaceutical is initially administered in March;

FIG. 4f is a sub-chart to determine the expiration date of the dispensed pharmaceutical when the pharmaceutical is initially administered in April;

FIG. 4g is a sub-chart to determine the expiration date of the dispensed pharmaceutical when the pharmaceutical is initially administered in May;

FIG. 4h is a sub-chart to determine the expiration date of the dispensed pharmaceutical when the pharmaceutical is initially administered in June;

FIG. 4i is a sub-chart to determine the expiration date of the dispensed pharmaceutical when the pharmaceutical is initially administered in July;

FIG. 4j is a sub-chart to determine the expiration date of the dispensed pharmaceutical when the pharmaceutical is initially administered in August;

FIG. 4k is a sub-chart to determine the expiration date of the dispensed pharmaceutical when the pharmaceutical is initially administered in September;

FIG. 4l is a sub-chart to determine the expiration date of the dispensed pharmaceutical when the pharmaceutical is initially administered in October;

FIG. 4m is a sub-chart to determine the expiration date of the dispensed pharmaceutical when the pharmaceutical is initially administered in November;

FIG. 4n is a sub-chart to determine the expiration date of the dispensed pharmaceutical when the pharmaceutical is initially administered in December;

FIG. 5 is an assembled view of FIG. 2;

FIG. 6 is an exploded view of a second embodiment of the pharmaceutical dispensing device, prescription label and pharmaceutical container wherein the pharmaceutical container may be placed within a receptacle affixed to a second portion of a pharmaceutical dispensing device;

FIG. 7 is an exploded view of a third embodiment of the pharmaceutical dispensing device, prescription label and pharmaceutical container wherein the prescription label may be affixed to a front surface of an envelope and the pharmaceutical container may be placed within the envelope;

FIG. 8 is an assembled view of a fourth embodiment of the pharmaceutical dispensing device, prescription label and pharmaceutical container wherein the device may define a substantially flat and rigid first portion and a cavity in which the pharmaceutical container may be placed within; and

FIG. 9 is a flow chart of a method of using the dispensing device.

### DETAILED DESCRIPTION OF THE INVENTION

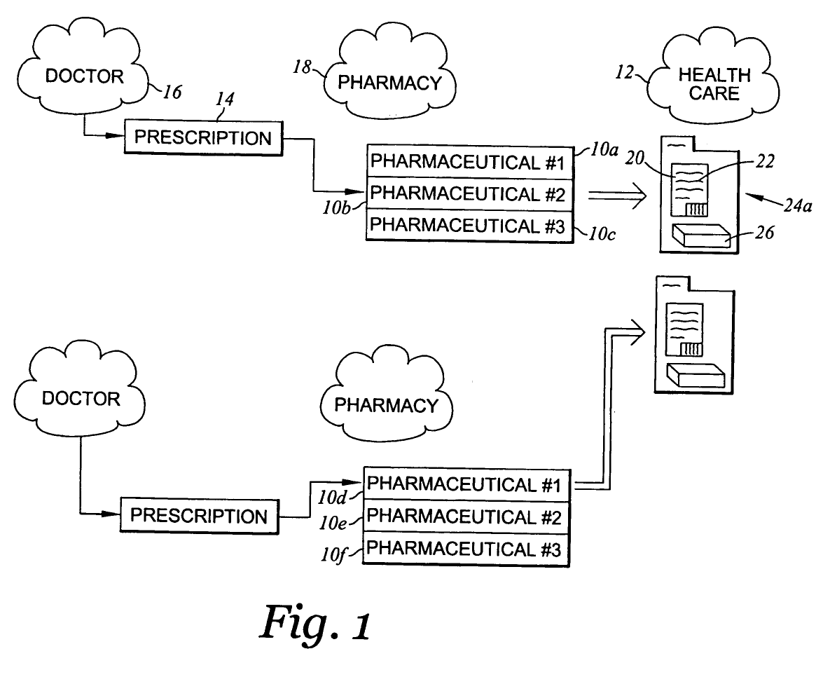

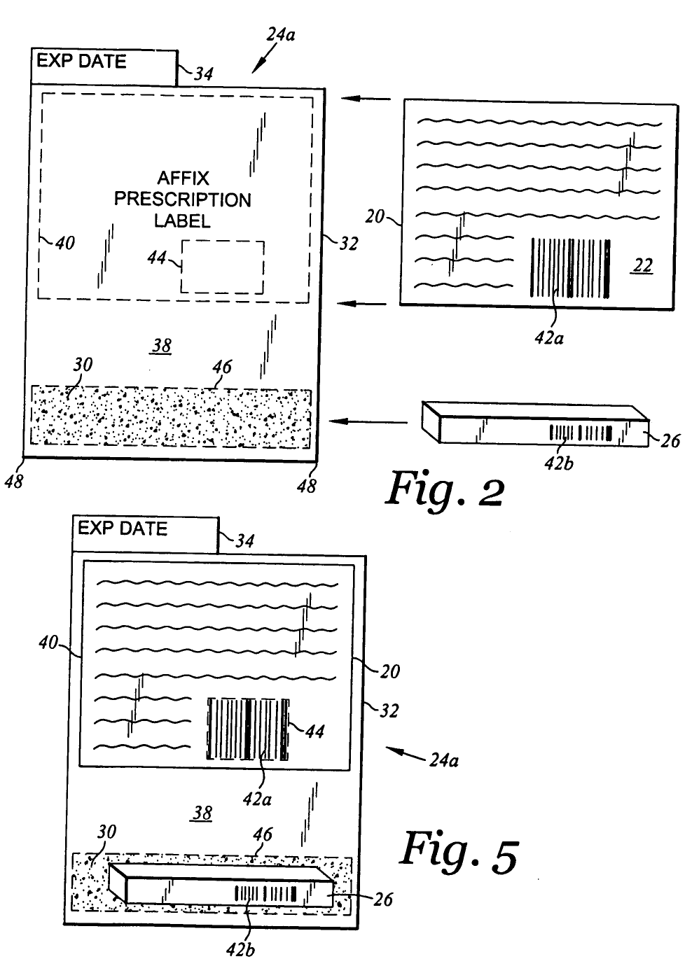

The drawings referred to herein are for the purposes of illustrating the preferred embodiments of the present invention and not for the purposes of limiting the same. As used herein, a pharmaceutical includes but is not limited to medication, emollient, cosmetic and ointment. FIG. 1 illustrates a process in which pharmaceuticals 10b and 10d of a plurality of pharmaceuticals 10a-f may be dispensed to a patient and collected at a health care provider 12 such as a nursing home. In particular, the patient may receive a prescription 14 from a doctor 16 to treat a health condition of the patient. The patient may fill the prescription 14 at a pharmacy 18. A pharmacist at the pharmacy 18 may prepare a prescription label 20 which may contain a variety of information such as doctor's name, dispense date, type of pharmaceutical, concentration, usage, warnings, bar code and other relevant information specific to the prescribed pharmaceutical and/or the patient. Additionally, the information may be placed or printed on a front surface 22 (see FIG. 2) of the label 20, and a back surface (not shown) of the label 20 may have adhesive placed thereon to affix the prescription label 20 to a pharmaceutical dispensing device 24a.

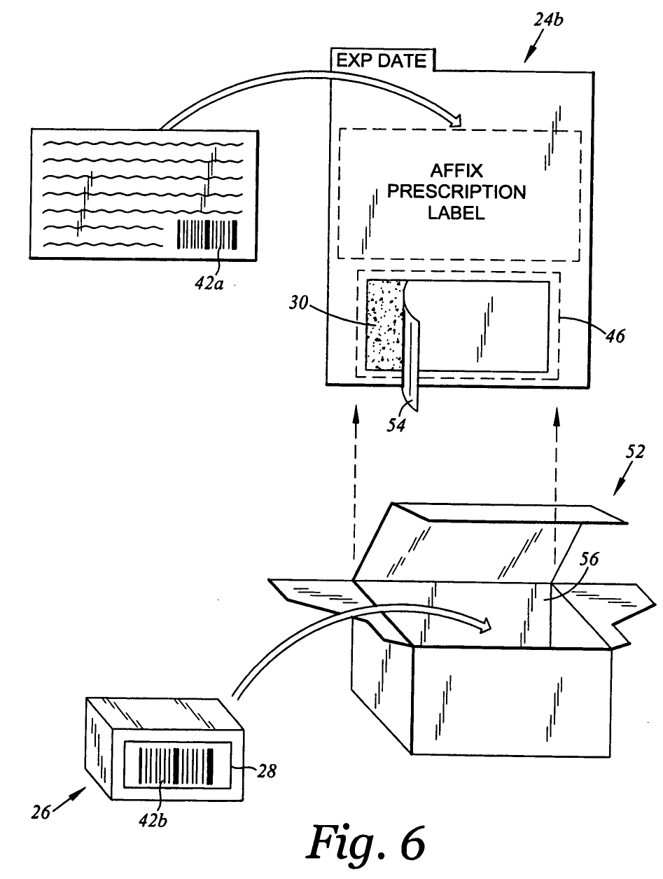

A pharmaceutical container 26 (see FIG. 6) may have affixed or indicated on its exterior surface a bar code label 28 (see FIG. 6) or bar code which may be unique to the pharmaceutical contained therein. The pharmaceutical container 26 shown in FIG. 6 is a folding carton but it is also contemplated within the scope of the present invention that the pharmaceutical container 26 may be a plastic bottle or vial. Thereafter, as shown in FIG. 5, the pharmacist may affix the prescription label 20 to the device 24a via the adhesive on the label's back surface and the pharmaceutical container 26 may be affixed to the device 24a via an adhesive 30 placed on the device 24a. As such, the prescription label 20 and the pharmaceutical may be conveniently retained together such that the pharmacist may rapidly scan the bar code of the prescription label 20 and the bar code label 28.

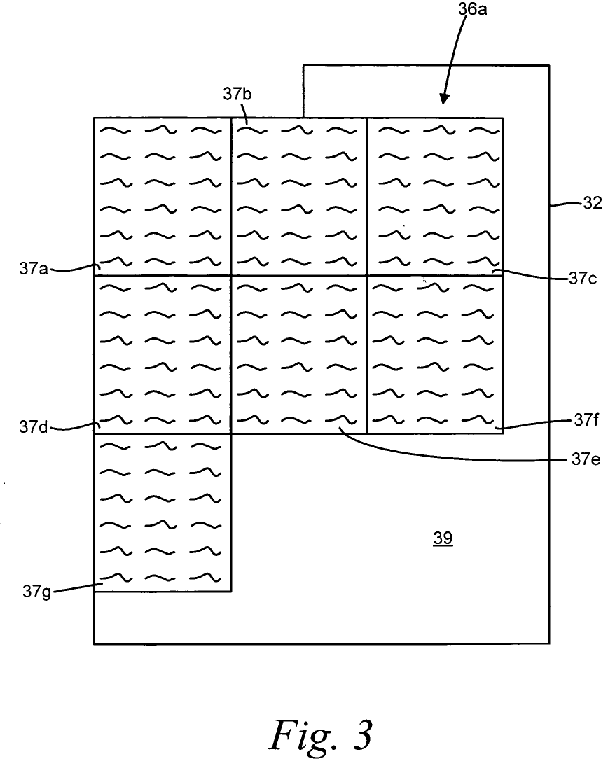

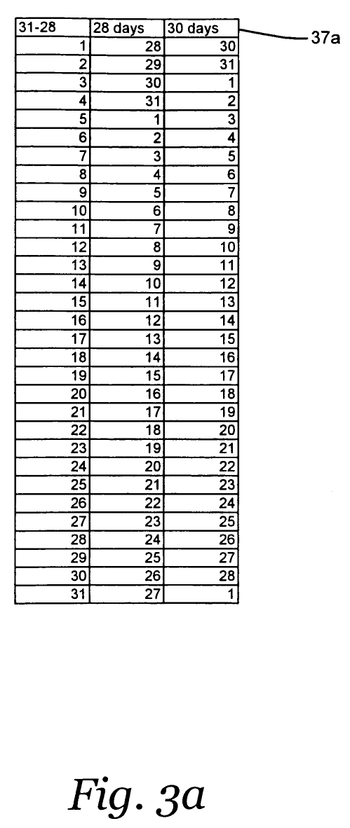

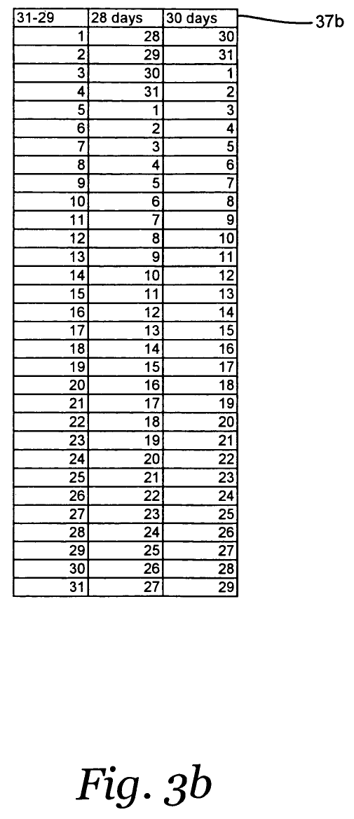

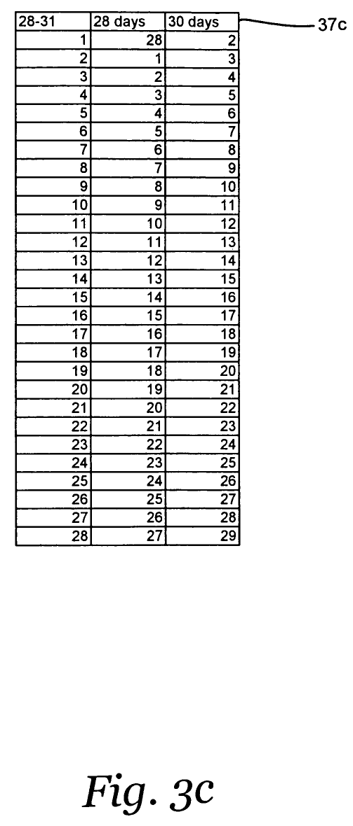

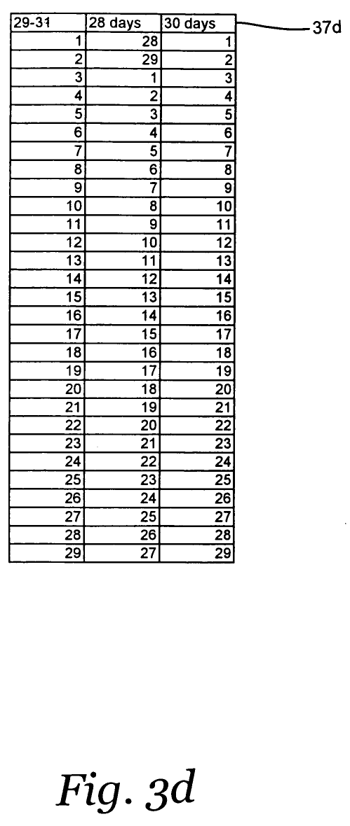

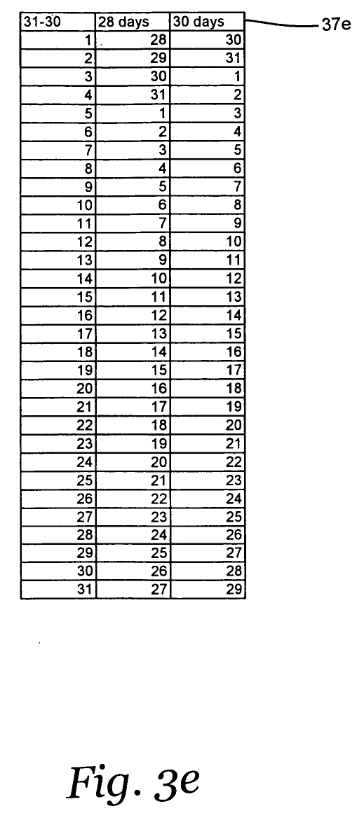

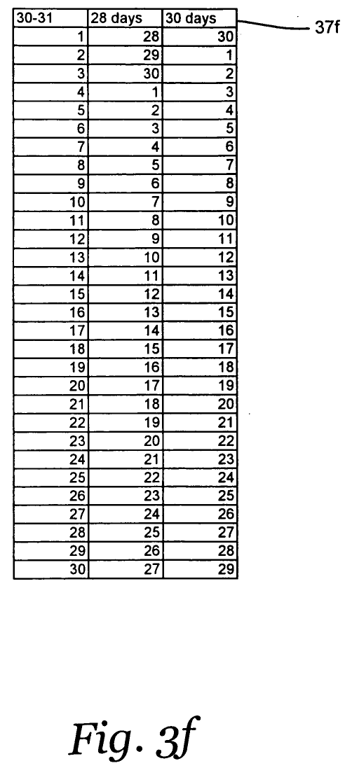

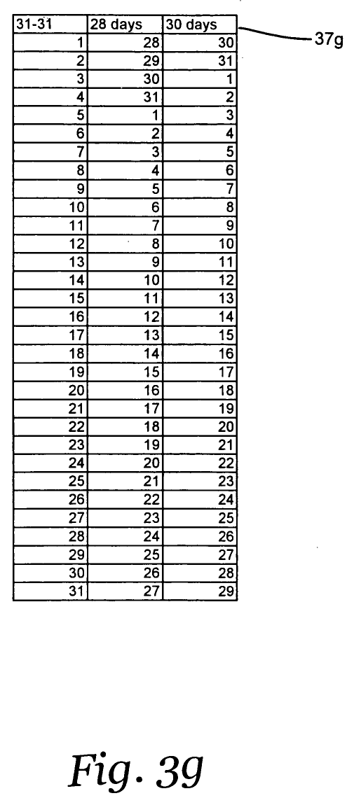

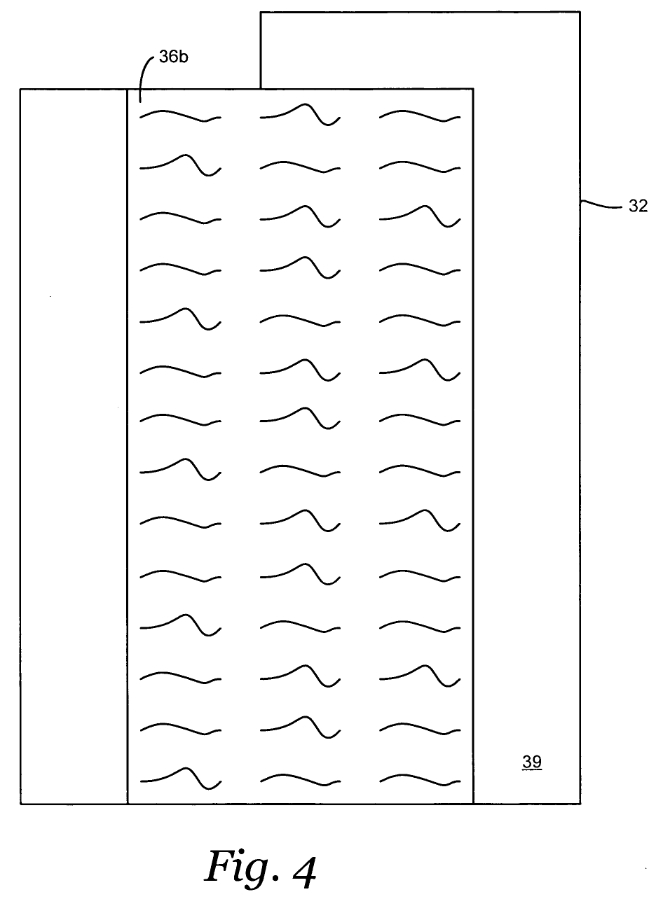

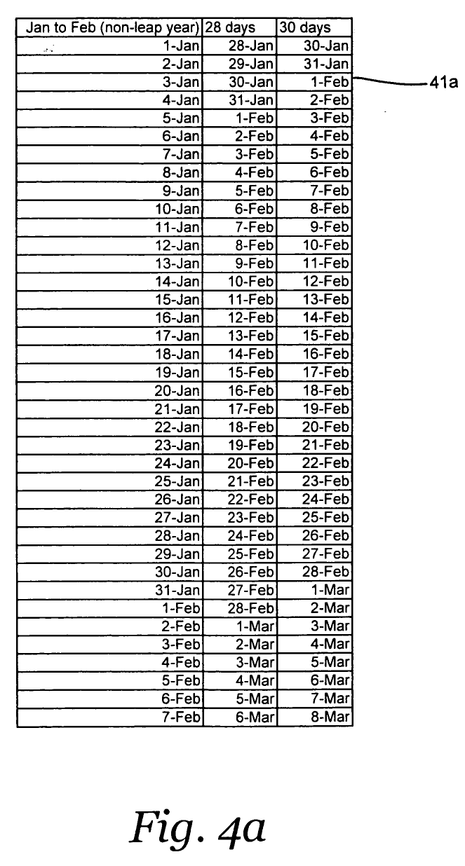

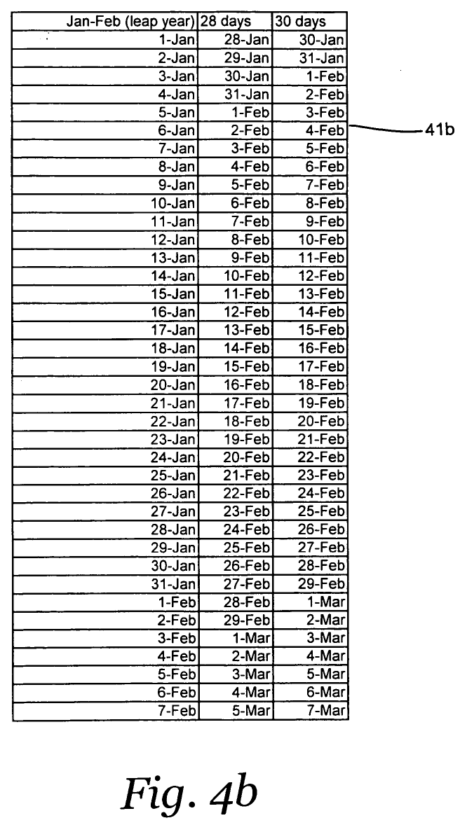

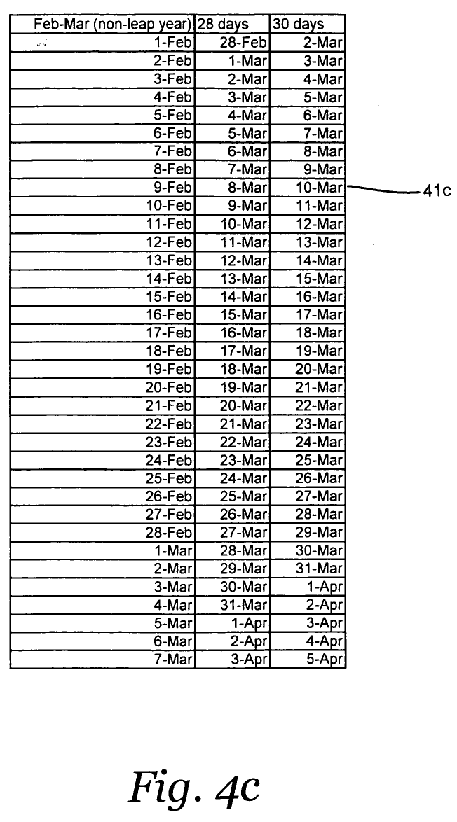

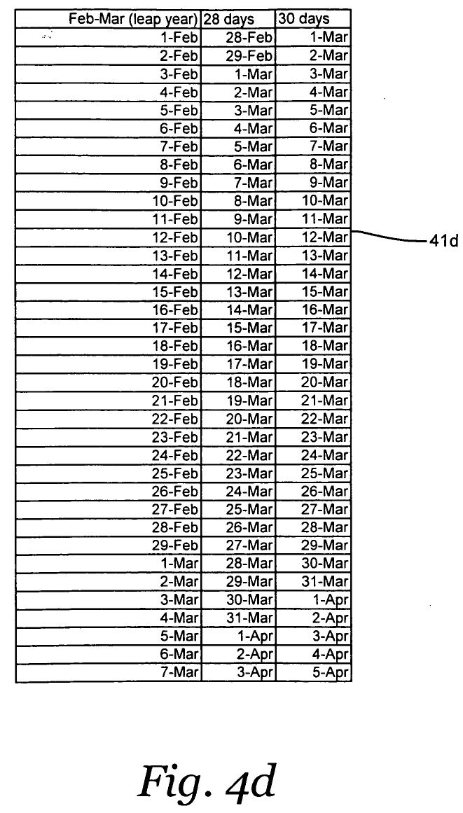

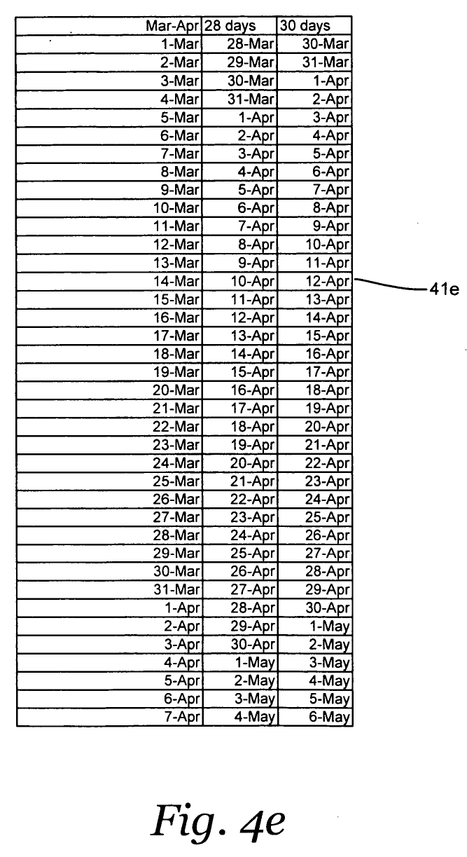

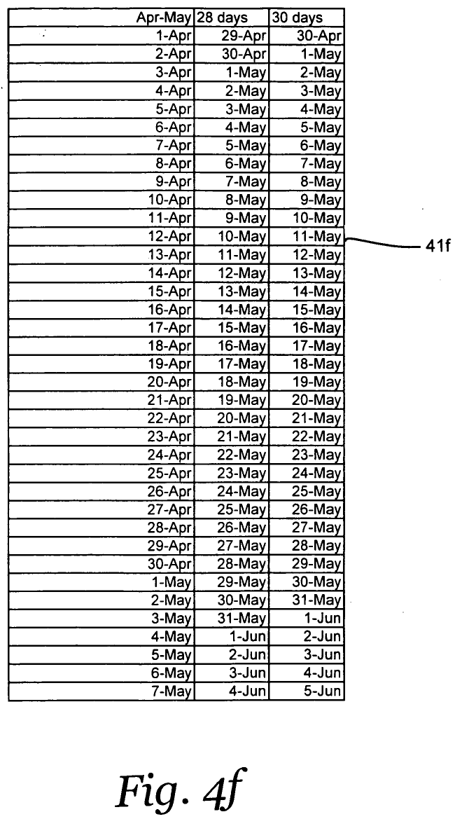

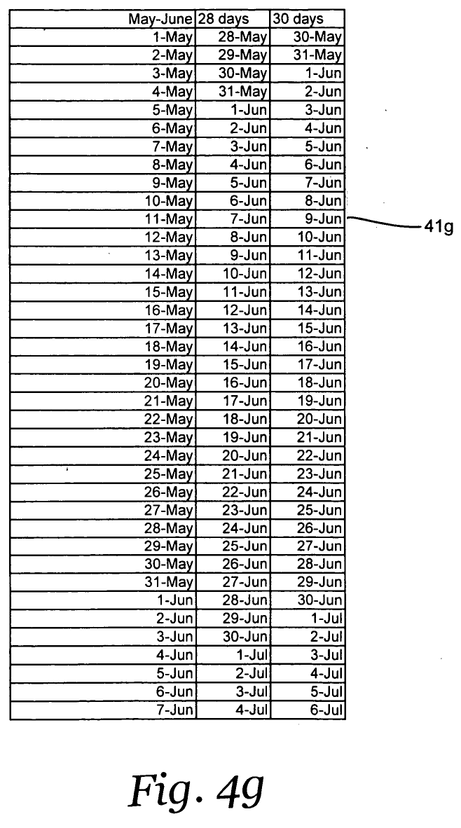

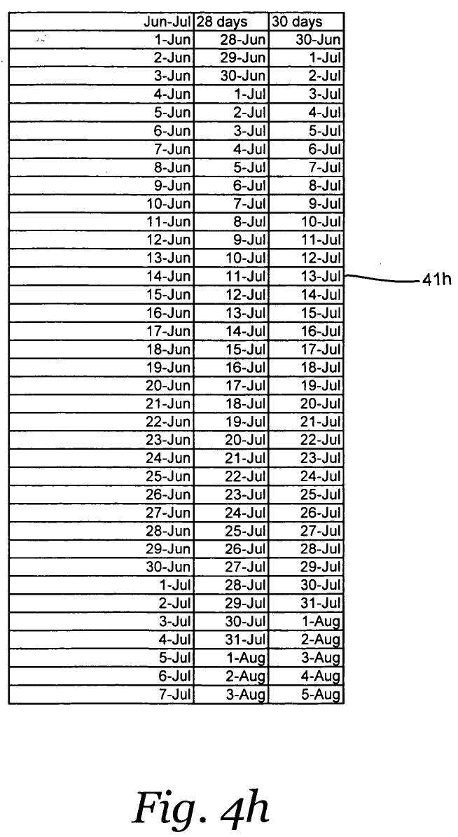

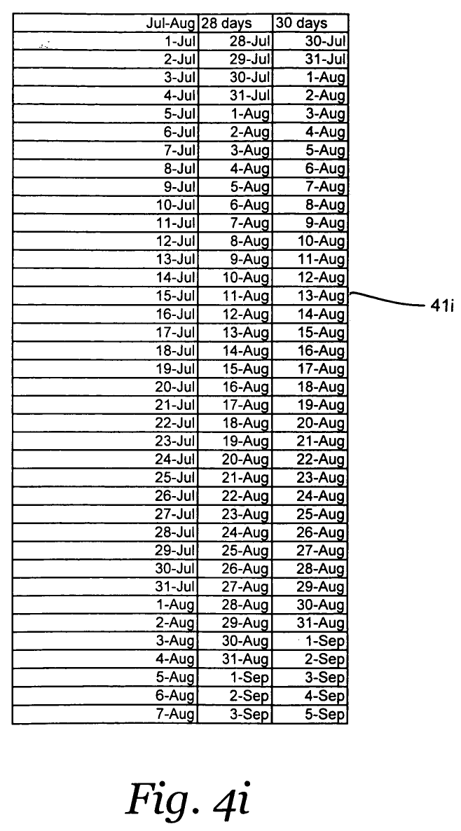

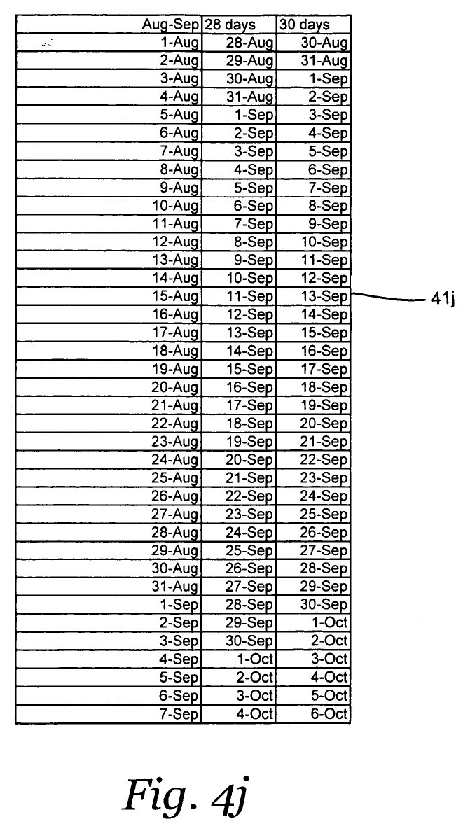

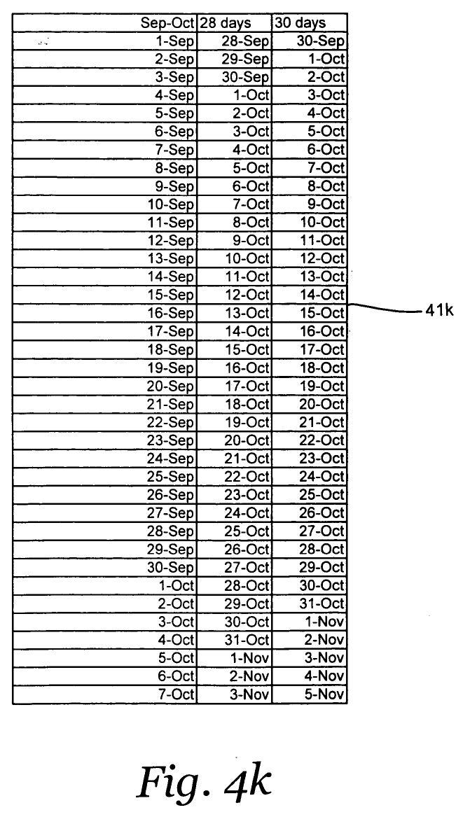

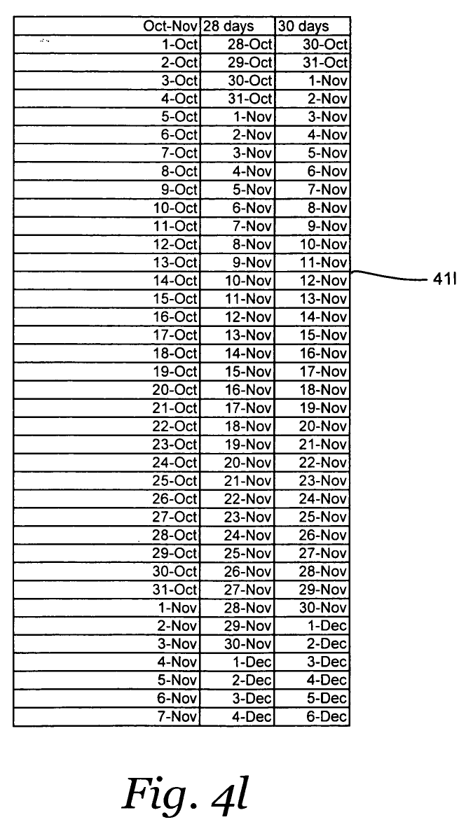

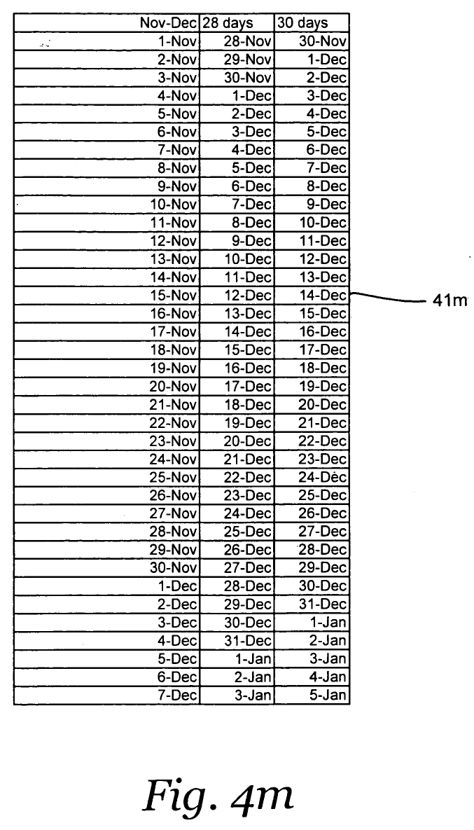

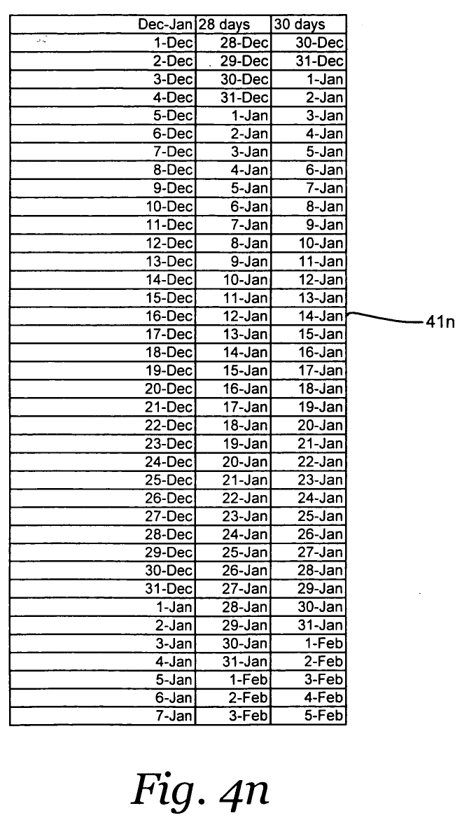

A first embodiment of the pharmaceutical device 24a is shown in FIGS. 1-3 and 5. The pharmaceutical device 24a may comprise a card or a substrate body 32 (see FIG. 2), the adhesive 30 (see FIG. 2), a portion 34 (see FIG. 2) for an expiration date and a chart 36a, b (see FIGS. 3 and 4). The card 32 may define a front surface 38 (see FIG. 2) and a back surface 39 (see FIG. 3). The front surface 38 of the card 32 may define the portion 34 for the expiration date. “EXP DATE” indicia may be placed thereon with space for writing in an expiration date of the pharmaceutical.

The front surface 38 may also define a substantially flat and rigid first portion 40. The first portion 40 is shown in FIG. 2 and indicated by the dashed rectangle. The first portion 40 may have affixed thereto the prescription label 20 (see FIGS. 2 and 5). The prescription label 20 may be affixed to the first portion 40 via an adhesive, double sided adhesive tape, staples or other attachment methods. The prescription label 20 may be flexible so as to conform to the shape of the first portion front surface 38 when affixed thereto. In this regard, the front surface 38 and its first portion 40 may be characterized as being substantially flat and rigid as long as a good optical scan of a prescription label bar code 42a (see FIGS. 2 and 5) may be obtained without having to flatten the first portion 40 by hand. In the alternative, a corresponding bar coded portion 44 (see FIGS. 2 and 5) of the first portion 40 may be substantially flat and rigid. The corresponding bar coded portion 44 may be defined by the location of the prescription label bar code 42a when the prescription label 20 is affixed to the first portion 40. The bar coded portion 44 is shown in FIGS. 2 and 5 and indicated by the dashed rectangle.

The front surface 38 may also define a second portion 46, as shown in FIGS. 2 and 5 and indicated by the dashed rectangle. The second portion 46 may have the adhesive 30 placed thereon. The adhesive 30 may also have a protective covering placed over the adhesive 30 to preserve the adhesive's tack prior to use of the device 24a. The adhesive 30 shown in FIG. 2 is shown as extending across the front surface 38 from the left side 48 to the right side 50 of the card 32. Alternatively, it is also contemplated within the scope of the present invention that the adhesive 30 is sized and configured to a back surface of the pharmaceutical container 26.

Accordingly, the prescription label 20 with adhesive on its back surface may be affixed to the first portion 40. Also, the protective covering may be peeled or otherwise removed from the adhesive 30 on the second portion 46 and the pharmaceutical container back surface may be affixed thereto. As such, the user (e.g., pharmacist) may pick up the dispensing device 24 and conveniently scan both bar codes 42a, 42b of the pharmaceutical container 26 and the prescription label 20 at the time the pharmaceutical is dispensed to the patient to ensure that the correct pharmaceutical will be administered to the patient. Further, the pharmacist does not have to manipulate the device 24a by opening the device 24a to scan both bar codes 42a, 42b. The bar codes 42a, 42b of the prescription label 20 and the pharmaceutical container 26 are both scannable from an external view of the device 24a (see FIG. 5). It is also contemplated within the scope of the present invention that the various aspects of the present invention may be variously embodied and employed such that the bar codes 42a and 42b are on opposite sides of the card/substrate body 32.

The device 24a may optionally have expiration date indicia of the pharmaceutical. This indicia may be placed on the front surface 38 of the card 32. More particularly, this indicia may be placed on the expiration date portion 34. The expiration date indicia may be printed, written or otherwise indicated on such portion 34.

The card 32 may have the chart 36a, b (see FIGS. 3 and 4) on its back surface for looking up the pharmaceutical's expiration date. For example, the chart 36a, b may be adhered or stapled thereto, or printed on the card 32. The chart 36b may be one of sub-charts 41a-n shown in FIGS. 4a-n which may be selectively attached to the back surface 39 of the card 32. These charts 41a-n may be provided to the pharmacist as pre-printed labels individually rolled. In other words, each of the charts 41a-n may be pre-printed on a roll of labels. If the pharmacist dispenses the pharmaceutical in the month of July then chart 41i may be adhered to the back surface 39 of the card 32. The charts 36a, b and card 32 shown in FIGS. 3 and 4 are not to scale compared to the card 32 shown in FIGS. 2 and 5 but they 36a, b, 32 have been enlarged for clarity. Details of the charts 36a, b and 41 are further illustrated in FIGS. 3a-3g and FIGS. 4a-4n.

Referring now to FIGS. 3 and 3a-g, the chart 36a may comprise a plurality of sub-charts 37a-g. For example, the chart 36a shown in FIG. 3 comprises seven sub-charts 37a-g. Details of the sub-charts 37a-g are shown in FIGS. 3a-3g. Each sub-chart 37 refers to a different set of months within the calendar year. For example, the sub-chart 37a shown in FIG. 3a refers to the months from January to March in non-leap years. The sub-chart 37b shown in FIG. 3b refers to the months from January to February in leap years. The sub-chart 37c shown in FIG. 3c refers to the months from February to March in non-leap years. The sub-chart 37d shown in FIG. 3d refers to the months from February to March in leap years. The sub-chart 37e shown in FIG. 3e refers to the months from March to April, May to June, August to September and October to November. The sub-chart 37f shown in FIG. 3f refers to the months from April to May, June to July, September to October and November to December. The sub-chart 37g shown in FIG. 3g refers to the months from July to August and December to January.

Referring now to FIGS. 4 and 4a-n, the chart 36b (see FIG. 4) may be one sub-chart 41 of a plurality of sub-charts 41a-n which are shown respectively in FIGS. 4a-n. Each different sub-chart may be printed on a roll of stickers and provided to pharmacists such that the pharmacist may adhered the appropriate sub-chart to the back surface 39 based on when the pharmaceutical container 26 is dispensed. For example, if the pharmaceutical is dispensed in January then sub-chart 41a or 41b may be adhered to back surface 39 depending on whether the current year is a leap year.

Each sub-chart refers to a different sequential set of months within the calendar year from January to February of the following year. For example, the sub-chart 41a shown in FIG. 4a refers to the months from January to March in non-leap years. The sub-chart 41b shown in FIG. 4b refers to the months from January to March in leap years. The sub-chart 41c shown in FIG. 4c refers to the months from February to April in non-leap years. The sub-chart 41d shown in FIG. 4d refers to the months from February to April in leap years. The sub-chart 41e shown in FIG. 4e refers to the months from March to May. The sub-chart 41f shown in FIG. 4f refers to the months from April to June. The sub-chart 41g shown in FIG. 4g refers to the months from May to July. The sub-chart 41h shown in FIG. 4h refers to the months from June to August. The sub-chart 41i shown in FIG. 4i refers to the months from July to September. The sub-chart 4j shown in FIG. 4j refers to the months from August to October. The sub-chart 4k shown in FIG. 4k refers to the months from September to November. The sub-chart 41 shown in FIG. 4l refers to the months from October to December. The sub-chart 4m shown in FIG. 4m refers to the months from November to January. The sub-chart 4n shown in FIG. 4n refers to the months from December to February.

Although the sub-charts 41a-n are shown extending seven days into the next month, it is also contemplated within the scope of the present invention that the various aspects of the present invention may be employed with sub-charts 41a-n that are truncated to the end of the current month. For example, although sub-chart 41a is shown extending to February 7, it is also contemplated within the scope of the present invention that the various aspects of the present invention may be employed with the sub-chart 41a truncated to January 31.

Alternatively, certain sub-charts 41a-n are substantially the same and may be merged. For example, the sub-charts 41e, 41g, 41j, 41l and the sub-charts 41f, 41h, 41k, 41m and the sub-charts 41i and 41n are substantially the same except for the differences in months. As such, the sub-charts in each group may be merged to reduce the number of rolls of stickers provided to the pharmacist.

The sub-charts 37a-g and 41a-n may be used by nurses and other medical personnel to look up an expiration date of the pharmaceutical. For example, if the pharmaceutical container 26 was opened on the seventh of January in a non-leap year and the pharmaceutical's expiration date is calculated from the date of opening, then an expiration date twenty eight (28) days later would be the third of February and an expiration date thirty (30) days later would be fifth of February as shown in FIG. 3a and FIG. 4a. In another example, if the pharmaceutical container 26 was opened on the 31th of January in a leap year and the pharmaceutical's expiration date is calculated from the date of opening, then an expiration date thirty (30) days later would be the twenty ninth of February, as shown in FIG. 3b and FIG. 4b. Additionally, in the examples above, the life of the pharmaceutical was determined to be twenty eight (28) or thirty (30) days after opening the pharmaceutical container 26. Other life spans may be indicated on the chart 36. For example, a life span of 45, 60 or 90 days may also be indicated on the chart 36.

The looked up expiration date may be indicated (e.g., written) on the expiration date portion 34. The device 24a with the attached prescription label 20 and pharmaceutical container 26 may be conveniently arranged in a drawer of a med cart such that a nurse at a nursing home may easily view all prescriptions to determine which prescriptions are about to expire and request additional medication.

In a second embodiment of the dispensing device 24b, as shown in FIG. 6, the same 24b may further comprise a receptacle 52 in addition to the various features described in relation to the first embodiment. As shown in FIG. 6, the protective covering 54 is removed from the adhesive 30 placed on the second portion 46 and the receptacle 52 may be affixed to the second portion 46. The receptacle 52 may be sized and configured to define a cavity 56 to receive the pharmaceutical container 26. This second embodiment may be employed when the pharmaceutical container back surface is less susceptible to adherence or affixation to the card second portion 46 such as when the pharmaceutical container 26 is a plastic bottle or vial.

The receptacle 52 may be any type of rigid or flexible material as long as it may be affixed to the second portion 46. The receptacle 52 may be transparent to allow a pharmaceutical container 26 placed within its cavity 56 to be viewable from outside and its bar code 42b optically scanned from the outside. The receptacle 52 shown in FIG. 6 may have a box configuration which may be traversed between open (see FIG. 6) and closed positions (not shown). Furthermore, the receptacle 52 and the card 32 may be fabricated from a unitary material.

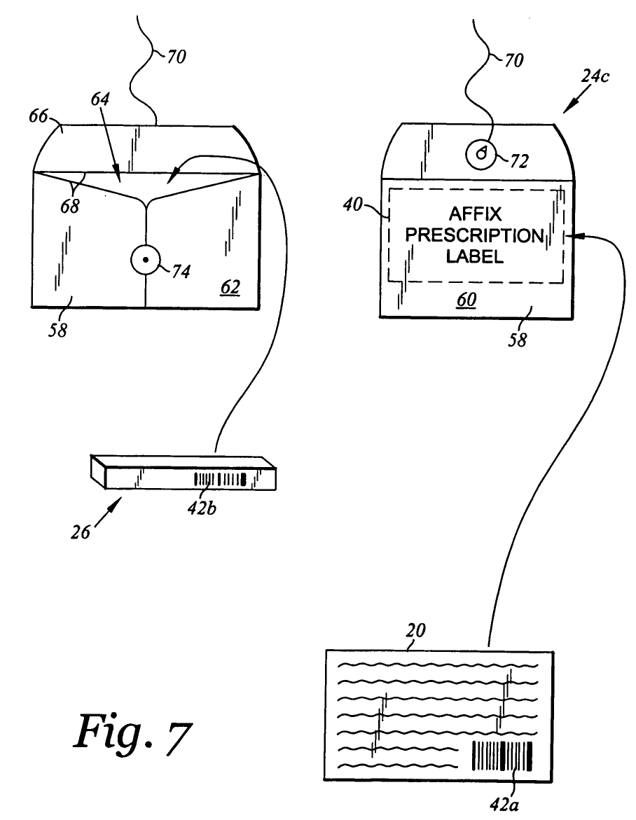

A third embodiment of the pharmaceutical dispensing device 24c is illustrated in FIG. 7. In particular, the device 24c may comprise an envelope or substrate body 58 defining a front surface 60, a back surface 62 and a cavity 64. The front surface 60 may define the first portion 40 to which the prescription label 20 may be affixed to. In this regard, the first portion 40 may also be substantially flat and rigid in the same manner as described in the first embodiment. This allows the user to have a good optical scan of the prescription label bar code 42a. Also, the cavity 64 may receive the pharmaceutical container 26. Since the envelope 58 may be fabricated from a transparent material, the bar code 42b of the pharmaceutical container 26 may be scanned through the envelope material.

The device 24c may further define a flap 66 traverseable between an opened position (see FIG. 7) and a closed position. The flap 66 may be attached to an aperture 68 of the envelope 58. More particularly, the envelope 58 may define the aperture 68 which leads to the envelope cavity 64, and the flap 66 may be attached to an edge of such aperture 68. The flap 66 may further have attached thereto a tie string 70 and a first closure button 72. The back surface 62 of the envelope 58 may also have attached thereto a second closure button 74. In use, the flap 66 may be traversed to the closed position once the pharmaceutical container 26 is placed within the envelope cavity 64. The tie string 70 may be wrapped around the first and second closure buttons 72, 74 so as to lock the flap 66 in the closed position. In this closed position, the pharmaceutical container 26 placed within the envelope cavity 64 may not be removed unless the tie string 70 is loosened from the first and second closure buttons 72, 74 and the flap 66 traversed to the open position (see FIG. 7).

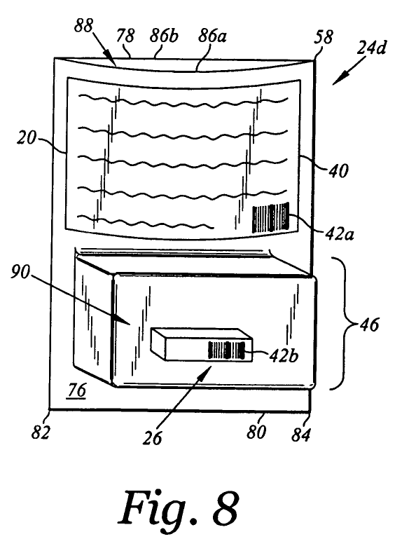

In a fourth embodiment of the present invention, as shown in FIG. 8, the device 24d may comprise a substrate body 58. The device 24d may also include the first portion 40 and the second portion 46 disposed about the substrate body 58. However, the first and second portions 40, 46 may be fabricated from a unitary material. For example, as shown in FIG. 8, the device 24d may be fabricated from a plastic material which has been injection molded. More particularly, a front layer or first substrate 76 and a back layer or second substrate 78 may have a clam shell configuration joined at bottom edges 80. Left and right edges 82, 84 of the front and back layers 76, 78 may be tack welded together. The top edges 86a, 86b may remain open so as to allow the removal and insertion of the pharmaceutical container 26 therefrom and therein, respectively.

The top edges 86a, b of the front and back layers 76, 78, respectively, may define the aperture 88. The aperture 88 may have a slightly open configuration. In other words, in its natural state, the top edges 86a, 86b of the front and back layers 76, 78 may have a slight gap. In particular, the front layer 76 may have a bowed or curved configuration and the back layer 78 may have a planar configuration. The first portion 40, and more particularly, a top portion of the front layer 76 may be slightly bowed. In this regard, despite the bow, the first portion 40 may be characterized as being substantially flat as long as the bar code 42a of the prescription label 20 affixed thereto may provide a good scan to an optical bar code reader/scanner. The gap may be sized to be smaller compared to the pharmaceutical container 26 such that the container 26 does not slip out of the second portion 46 when the device 24 is flipped over.

The second portion 46 may be defined by lower portions of the front and back layers 76, 78. In this regard, the second portion 46 defines a cavity 90 into which the pharmaceutical container 26 may be placed within. In particular, the lower portion of the back layer 78 may be planar, and the lower portion of the front layer 76 may have a depression or bubble. The depression and the back layer 78 may define the cavity 90.

In use, the pharmaceutical container 26 may be placed into the cavity 90 via the aperture 88. In other words, the aperture 88 may be spread open so as to allow passage of the pharmaceutical container 26 to the cavity 90. The front layer 76 which may be transparent allows the user to scan the bar code 42b of the pharmaceutical container 26. The top portion of the front layer 76 (i.e., first portion) may have affixed thereto the prescription label 20 to allow scanning of its bar code 42a via the optical scanner. Hence, as shown in this embodiment, the pharmacist may pick up the device 24d and scan the prescription label bar code 42a and the pharmaceutical container bar code 42b without having to remove the pharmaceutical container 26 from the device 24d.

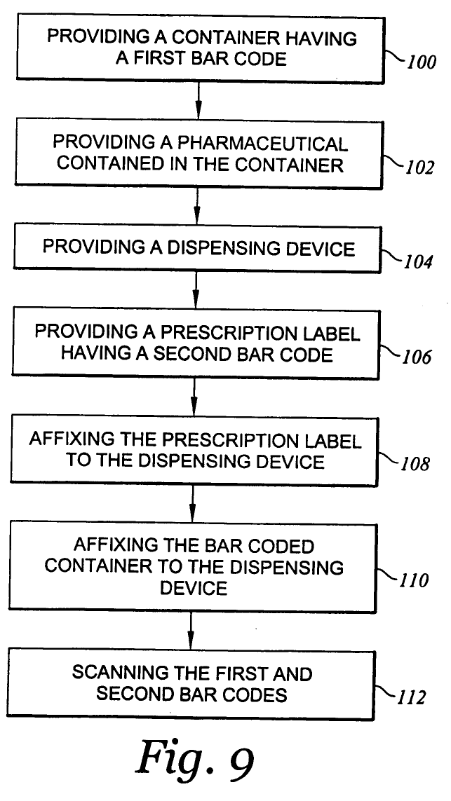

In a fifth embodiment of the present invention, a method of using the dispensing device 24a, b, c or d is provided. As shown in FIG. 9, step 100 recites the step of providing a pharmaceutical container 26 wherein the container 26 has a container bar code or first bar code 42b. Step 102 recites the step of providing a pharmaceutical contained in the bar coded container 26. Although steps 100 and 102 are recited as two separate steps, these steps may be combined into a single step of providing a container 26 having a container bar code 42b and containing a pharmaceutical. Step 104 recites the step of providing a dispensing device 24. In this regard, the dispensing device 24 may be any of the dispensing devices 24a, b, c, or d discussed above. Step 106 recites the step of providing a prescription label 20 having a prescription label bar code or second bar code 42a. Step 108 recites the step of affixing the bar coded prescription label 20 to the dispensing device first portion 40. Step 110 recites the step of affixing the bar coded container 26 to the dispensing device second portion 46. Step 112 recites the step of scanning the first and second bar codes 42a, b.

This description of the various embodiments of the present invention is presented to illustrate the preferred embodiments of the present invention, and other inventive concepts may be otherwise variously embodied and employed. The appended claims are intended to be construed to include such variations except insofar as limited by the prior art.

What is claimed is:

1. A dispensing device for retaining a bar coded prescription label including a prescription label bar code and a bar coded container including a container bar code together, the container containing a pharmaceutical associated with the prescription label bar code and the container bar code, the device comprising:
a substrate body;
a substantially rigid and flat first portion disposed about the substrate body for affixing the bar coded prescription label thereto; and
a second portion disposed about the substrate body for affixing the bar coded container thereto.

2. The device of claim 1,wherein the first portion is sized and configured to the prescription label.

3. The device of claim 1 wherein the bar coded container is affixable to the second portion via an adhesive interposed between the second portion and bar coded container.

4. The device of claim 3 wherein an area of the second portion may have the adhesive placeable thereon and the area thereof is sized and configured to a back surface of the bar coded container.

5. The device of claim 1 wherein the bar coded container is affixable to the second portion via a receptacle which is affixable to the second portion and defines a cavity for receiving the bar coded container.

6. The device of claim 5 wherein the receptacle is affixable to the second portion via an adhesive and an area of the second portion may have the adhesive placed thereon and the area thereof is sized and configured to a back surface of the receptacle.

7. The device of claim 5 wherein the receptacle defines an aperture for inserting and removing the bar coded container therein and therefrom, respectively, and the receptacle includes a flap attached to an edge of the aperture and foldable over the aperture to a closed position for blocking the aperture and preventing the bar coded container contained within the receptacle cavity from being removed therefrom.

8. The device of claim 5 wherein the receptacle is a pouch.

9. The device of claim 5 wherein the receptacle is an envelope.

10. The device of claim 5 wherein the receptacle is a bag.

11. The device of claim 1 further comprising a chart disposed on the substrate body for looking up an expiration date of the pharmaceutical.

12. The device of claim 11 wherein the substrate body defines an expiration date portion such that an expiration date indicia of the pharmaceutical may be indicated on the expiration date portion.

13. The device of claim 1 wherein the substrate body is fabricated from a resilient material.

14. The device of claim 13 wherein the resilient material is a paper board material.

15. The device of claim 13 wherein the resilient material is a plastic material.

16. The device of claim 1 wherein the substrate body, first portion and the second portion are fabricated from a unitary material.

17. A dispensing device for retaining a bar coded prescription label including a prescription label bar code and a bar coded container including a container bar code together, the container containing a pharmaceutical associated with the prescription label bar code and the container bar code, the device comprising:
a substrate body defining a cavity and an aperture leading to the cavity for inserting and removing the bar coded container therein and therefrom, respectively, the cavity being sized and configured to receive the bar coded container; and
a substantially flat and rigid portion disposed about the substrate for affixing the bar coded prescription label thereto.

18. The device of claim 17 wherein the body has a transparent portion for allowing the container bar code of the bar coded container to be optically scanned when the bar coded container is inserted in the cavity.

19. The device of claim 17 further comprising:
a flap attached to an edge of the aperture traverseable to a closed position;
a body closure button attached to the substrate body; and
a tie string and flap closure button attached to the flap wherein the flap may be traversed to the closed position and the tie string wrapped about the body closure button and the flap closure button to lock the flap in the closed position preventing removal of the bar coded container inserted in the cavity.

20. The device of claim 17 wherein the substrate body includes a first substrate and a second substrate, and the cavity is defined by a bubble formed in the first substrate and the second substrate.

21. A method of dispensing a pharmaceutical comprising the steps of:
a) providing a bar coded container having a container bar code;
b) providing a pharmaceutical contained in the bar coded container;
c) providing a bar coded prescription label including a prescription label bar code wherein information indicated on the prescription label and the prescription label bar code is based on the pharmaceutical contained in the bar coded container;
d) providing a dispensing device for retaining the bar coded prescription label, the bar coded container and the pharmaceutical together, the device comprising a substrate body, a substantially rigid and flat first portion disposed about the substrate body for affixing the bar coded prescription label to the substrate body, and a second portion disposed about the substrate body for affixing the bar coded container to the substrate body;
e) affixing the bar coded prescription label to the first portion;
f) affixing the bar coded container to the second portion; and
g) scanning the first and second bar codes.

22. The method of claim 21 wherein step e) comprises the step of adhering the bar coded prescription label to the first portion.

23. The method of claim 21 wherein step f) comprises the step of adhering the bar coded container to the second portion.

24. The method of claim 21 wherein the device of step d) further comprises a receptacle affixed to the second portion and step f) comprises the step of placing the bar coded container into the receptacle.

25. The method of claim 21 wherein the second portion of step d) defines a cavity for receiving the bar coded container and step f) comprises the step of inserting the bar coded container into the cavity.
